(19) United States
(12) Patent Application Publication
(10) Pub. No.: US 2004/0160612 A1
(43) Pub. Date: Aug. 19, 2004

(54) Device and method for local resolution measurement of the thickeness of a layer

(76) Inventors: Dieter Grafe, Jena (DE); Martin Kuhner, Jena (DE); Hans-Jurgen Dobschal, Kleinromstedt (DE)

Correspondence Address: Douglas J Christensen, Patterson Thuente Skaar & Christensen, 4800 IDS Center, 80 South 8th Street, Minneapolis, MN, 55402, US

(21) Appl. No.: 10/482,443

(22) PCT Filed: Jun. 11, 2002
(86) PCT No.: PCT/EP02/06401

(30) Foreign Application Priority Data
Jun. 29, 2001 (DE) 101 31 684.4

(51) Int. Cl. G01B 11/06

(52) U.S. Cl. 356/632; 356/503

(57) ABSTRACT

A device is provided for spatially resolved measurement of the thickness of a layer located on a sample carrier (7), said device comprising a light source (1-3) emitting polychromatic radiation with a predetermined spectral composition, illumination optics (4-6) illuminating the sample carrier (7) with radiation from the light source (1-3), detector optics (6, 5, 8) picking up radiation reflected by a line-shaped portion of the sample carrier (7) and guiding said radiation to a polychromator (9, 11) as a line-shaped beam, said polychromator (9, 11) separating the line-shaped beam into a field-shaped spectrum, and a camera (12), which receives the field-shaped spectrum, the polychromator (9, 11) being tuned to the spectral composition of the radiation from the light source.

The invention relates to a device as well as to a method for spatially resolved measurement of a thickness of a layer located on a sample carrier, wherein said sample carrier is illuminated by a light source with polychromatic radiation of a predetermined spectral composition, and radiation reflected by the sample carrier is detected.

This concept is employed, in particular, for detection of physicochemical or biochemical interactions at a layer whose thickness changes as a function of said interactions, in order to detect physico-chemical, biochemical or biological processes.

DE 42 000 88 A1 describes a method as well as a device for detecting physical, chemical, biochemical or biological processes, wherein a sample spot is irradiated with radiation via a light-conducting fiber and interference phenomena caused in a thin layer located at said sample spot are measured in that the radiation is picked up using the light-wave guide, guided to a detector by means of a Y-coupling and sensed there. In doing so, interference phenomena are detected by means of changes in intensity at one or more wavelengths, which changes may be interpreted and represented as a change in the optical layer thickness, i.e. as a change in the product of refractive index and layer thickness. The device allows only individual measurements to be carried out; simultaneous measurements of a plurality of samples are not possible. Therefore, the evaluation of several samples has to be sequentially effected, which is relatively time-consuming.

This aspect is improved in the device according to WO 97/040366, which enables a parallel evaluation of several sample elements located on a surface. The entire surface is illuminated with monochromatic light of a predetermined wavelength and light reflected by said surface is detected by means of a spatially resolving detector. Thus, spatially resolved sensing of the product of refractive index and layer thickness is effected. Several samples arranged on a carrier plate in the manner of a matrix are simultaneously irradiated. Further, it is envisaged to apply light of a different wavelength to all samples, after they have been irradiated with light of a predetermined wavelength, and, in turn, to obtain corresponding measured values. Therefore, the light source from which the illumination light comes is provided to be tunable. This concept allows to detect changes of the spectral reflection behavior. However, in doing so, the number of possible spectral channels is identical with the number of different images which are recorded by the camera at respective different wavelengths, so that the spectral resolution is limited as a function of the measuring time.

It is an object of the invention to improve a device or a method of the aforementioned type in such a manner that not only a high degree of paralleling regarding different samples arranged on a carrier is achieved, but, at the same time, also a better spectrally resolved analysis is achieved.

This object is achieved by a device for spatially resolved measurement of the thickness of a layer located on a sample carrier, said device comprising a light source emitting polychromatic radiation with a predetermined spectral composition, illumination optics for illuminating the sample carrier with radiation from the light source, and detector optics picking up radiation reflected from a line-shaped portion of the sample carrier and guiding said radiation to a polychromator as a line-shaped beam or image, said polychromator dividing the line-shaped beam or image into a planar, multiple-line spectrum.

Thus, a line-shaped portion of the sample surface is imaged onto the polychromator, e.g. into its entrance slit. At the polychromator, there is, thus, a line-shaped image of the corresponding portion of the layer located on the sample surface. In connection with the optical beam path in this image, reference is made hereinafter to a line-shaped beam.

Thus, the device detects line-type spatial information on the sample carrier every time it records an image and disperses each partial area of the line which would, without a spectral analysis, be imaged onto a pixel of the camera into a full spectrum. Accordingly, a full spectrum of the line-type or line-shaped portion of the sample carrier, i.e. of the line-type spatial information on the sample carrier, is obtained with one single image taken by the camera. Thus, the device provides the spectral information by one single image-recording much quicker than was possible in the prior art, which required a separate illumination for each spectral channel with a separate image recording. Thus, drift phenomena between measurements made with a time difference in the individual spectral channels are eliminated and no longer affect the result of measurement. This makes complex reference measurements dispensable because drift phenomena are reduced to a negligible extent. Since the layer thickness can further be determined on the basis of data obtained from one single image taken by the camera, errors, such as small offset differences between the individual measurements, are no longer relevant.

Further, the advantage is achieved that the light source can be of a simpler design, because it no longer needs to be spectrally tunable. In addition, the polychromator is preferably tuned to the spectral composition of the radiation from the light source in order to achieve an optimal spectral resolution.

Optical resonance phenomena are influenced by deposition or linking or by a change in the deposition or linking on stratified biochemical sample carriers. This shows up as changes in a reflection spectrum, in particular by displacement of individual points in the spectrum, such as extreme values, turning points etc. In particular, a resonance structure, whose spectral position changes with depositions or reactions or interactions at the observed layer, appears in a reflection spectrum after irradiation of white light or of light of a predetermined spectral composition. On the whole, the device according to the invention, in particular due to the large number of spectral channels, allows a detection sensitivity to mass depositions of a few pg/mm² or of changes in layer thickness in the order of 1 ppm.

It is essential to the concept according to the invention that reflected radiation is picked up from a line-shaped portion of the illuminated sample surface and spectrally dispersed in the polychromator. The image taken as a line-shaped reflection beam on the sample surface is dispersed transversely of the line direction into a two-dimensional field in the polychromator. Said field may then be detected by a camera in a spatially resolved and wavelength-resolved manner.

The width of the line-shaped reflection beam influences the spectral resolution as much as the spectral resolution of the polychromator. For optimal spectral analysis, it is preferred to tune the width of the line-shaped portion to the size of the pixels of a camera, so that the pixel size corresponds to the line width.

The line-shaped image may be guided to a polychromator either directly, or via an entrance slit, wherein the width of the image width or of the slit determines the spectral resolution of the polychromator and the height of the image or of the slit carries the spatial information of the line-shaped illumination of the sample. When using what is called an imaging polychromator, one dimension of the planar sample chip is imaged onto the full image height of the camera and the width of the line-shaped image, which is perpendicular to the former, is imaged onto the width of the slit. The polychromator then images the width of the slit preferably onto one or few pixel widths.

The device according to the invention may irradiate the entire sample surface with light simultaneously. However, in order to achieve as intense an irradiation as possible and, at the same time, illuminate only those portions of the sample carrier from which reflections are picked up, it is preferable that the illumination optics illuminate the line-shaped portion of the sample carrier with a line-shaped illumination beam. Since, in doing so, the portions of the sample carrier from which no reflected radiation is picked up remain unilluminated, samples which can be illuminated for a short time only, because they would be damaged by longer radiation, for example, can also be measured with such a device.

In order to measure a sample surface having a larger extension than the line-shaped portion, a corresponding relative movement may be provided between the sample surface and the detector optics. Conveniently, the sample is moved properly for this purpose.

Two-fold imaging is then effected: On the one hand, as already discussed above, a line-shaped portion of the sample surface is imaged onto the polychromator by the detector optics. On the other hand, the illumination optics effect imaging of the same portion of the sample surface into the source of illumination, but opposite the light propagation direction of said illumination.

Alternatively, a scanning means may be provided which deflects the illumination beam over the sample carrier. Said scanning means is conveniently located in the pupil of the illumination optics provided as an objective and, conveniently at the same time, in the pupil of the detector optics also provided as an objective. In an embodiment, which is particularly easy to realize and to manufacture, the scanning means comprises a movable mirror, which directs the illumination beam onto the sample carrier and picks up the reflected radiation. Since, in this connection, no substantial demands are made as to the moving speed of the mirror, possible frequencies of deflection do not play a major role. This is different as regards the position stability of the scanner, which is linked with the size and density of the arrangement of the spots arranged on the sample carrier.

The basis for the scanner design is the size of the spots applied as well as the number of spectral channels, which is given by the camera and the spectral resolution of the polychromator. During scanning of a sample carrier, the line-shaped portion is displaced by one pixel, and a spectrum is recorded again of this new line-shaped portion, i.e. of each pixel along the line-shaped portion. The line displacement with its associated image recording is continued until the entire area of the sample carrier covered with samples has been scanned. Thus, for each spatial region resolvable by the pixel size, there is an associated spectrum from which the layer thickness may be determined by algorithms known to the person skilled in the art.

For example, in a camera having 1,000 pixels, the line-shaped portion is split up into 1,000 elements in a spatial direction. If 10 pixels cover one spot on the sample carrier, 100 spots may be detected, and a planar scan of a spot requires 10 camera frames. By this approach of scanning a single spot with several camera frames by differently positioned line-shaped portions, a satisfactory result of measurement can be obtained also from inhomogeneous spots. Of course, the values may also be selected differently, with 5 to 10 camera frames per spot, i.e. optical imaging onto the camera with 5 to 10 pixels covering the spot diameter has proven to be convenient to sufficiently consider inhomogeneities of the spot surface area.

Since, in some cases, the spatial information should have a higher resolution than the spectral information, cameras having rectangular detector arrays are preferred, because then, for example, 1,000 pixels may be realized in the spatial direction and about 100 to 200 spectral channels in the spectral direction. In order to increase the speed of the layer calculation, several pixels may be combined in one spectral channel, which is referred to as pixel binning. In the same manner, several adjacent pixels may be combined or binned in the spatial coordinate as well.

For an optimal spectral resolution of the polychromator, the detector optics conveniently comprise an entrance slit preceding the polychromator. The detector optics are then provided such that the sample carrier is located in the object plane and is imaged into the plane of the entrance slit from there.

In order to irradiate the sample surface with a line-shaped illumination beam, an illumination slit is conveniently arranged following the light source, said illumination slit generating the line-shaped illumination beam. Further, subsequent illumination optics image the illumination slit into an object plane in which the sample carrier is located. A particularly good line formation is obtained with anamorphotic optics, for example a cylinder lens, being arranged preceding or following the illumination slit. A suitable light source is, for example, a white light source, such as a halogen lamp or also one or more LED(s). Use is preferably made of white light LEDs which are arranged in a row and illuminate the illumination slit.

Further information which may be used to evaluate the layer thickness at the sample carrier can be obtained from measurements using different polarization directions. In doing so, an oblique incidence of light onto the sample surface is preferred, because there are usually no differences in the reflected radiation intensity with regard to the polarization directions, when the light is vertically incident. If vertically and parallely polarized reflection radiation is measured with an oblique reflection, two independent sets of data are obtained for calculating the layer thicknesses. By doing so, for example, a distinction may be made between covered and uncovered spots, depending on the contrast. Further, a second, independent measured value is available then, which may be included in the statistics or in the referencing of the method of measurement.

Generally, stronger reflections are regularly obtained for a polarization direction which is perpendicular to the plane of incidence. For a vertical reflection, the illumination beam path needs to be separated from the detection beam path, which may be accomplished by a beam splitter. Such splitter is preferably arranged between the illumination optics and the scanner means. An oblique angle of incidence does not require separation of the incident radiation from the reflected radiation, which eliminates losses as caused, for example, by a beam splitter.

The object underlying the invention is further achieved by a method of measuring the thickness of a layer present on a sample carrier, wherein said layer is illuminated with polychromatic radiation of a predetermined spectral composition, reflected radiation is picked up as a line-shaped reflection beam from a line-shaped portion of said layer, the line-shaped reflection beam is separated into a planar, multiple-line spectrum, and the radiation intensity of the multiple-line spectrum is detected in a spatially resolved manner.

The method according to the invention enables a highly parallel measurement, so that, for example, up to 10,000 sample spots may be arranged on sample carriers of about 10*10 mm². Since spectra comprising a large number of spectral channels can be picked up, the reflection spectrum and changes thereof due to linking processes may be sensed more precisely, so that even small changes in the deposition density in the order of few pg/mm² may be detected from the measured signal.

In order to measure a planar sample carrier, it is preferable to illuminate the layer with a line-shaped illumination beam which is guided over the sample carrier. Optionally, the line-shaped portion from which the reflected radiation is detected may also be displaced over the sample carrier.

The device is advantageously applicable, in particular, in the measurement of layer thicknesses or changes in layer thickness during synthesis of molecules, substances or organic materials. Thus, on-line process monitoring is possible.

The invention will be explained in more detail below, by way of example and with reference to the Figures, wherein:

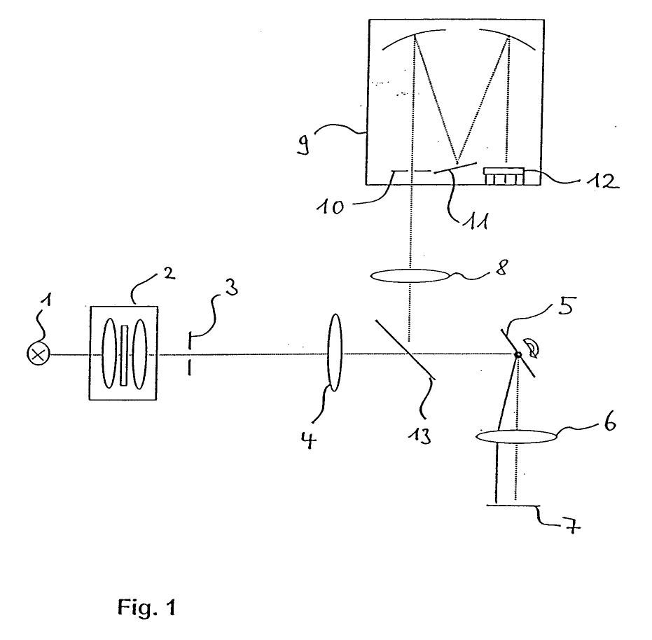

FIG. 1 shows a schematic representation of a first embodiment of a device for measuring the spatially resolved thickness of a layer present on a sample carrier,

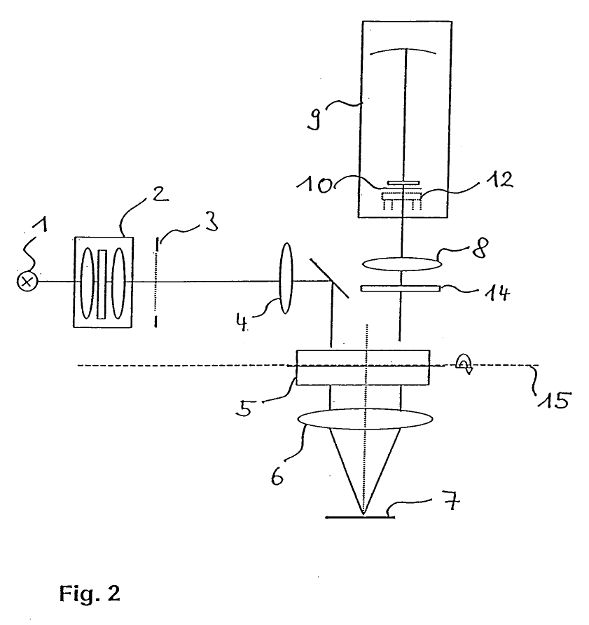

FIG. 2 shows an alternative embodiment of a device similar to FIG. 1,

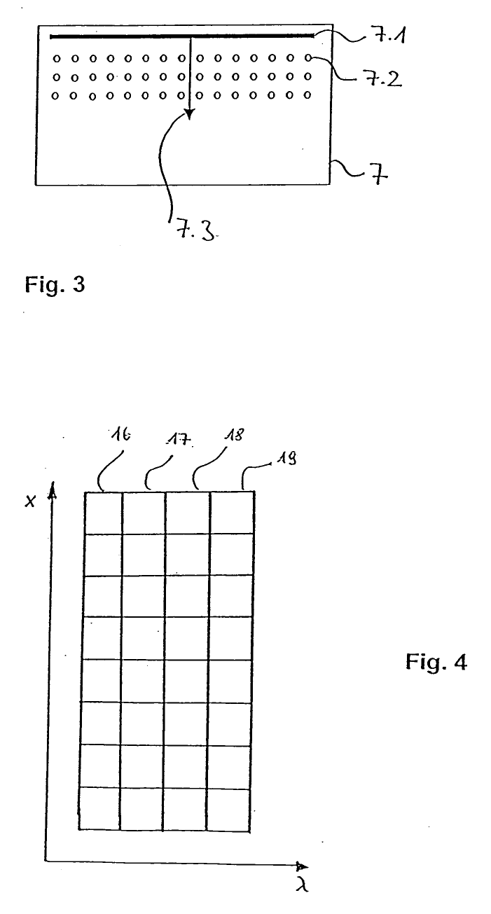

FIG. 3 shows a schematic representation of a line scan over a sample surface, and

FIG. 4 shows the illumination of a camera field located in a focal plane of a polychromator of the device according to FIG. 1 or 2.

FIG. 1 shows a device for measuring the thickness of a layer located on a sample carrier. In this case, the sample carrier is a so-called a biochip, on which a multiplicity of samples are applied in the form of so-called spots. Each spot has a minimum diameter of 0.1 mm. For a total surface area of 10 mm*10 mm, there is a total of 10,000 spots on the chip.

The layer comprises a polymer coating having reagents which exhibit an increase in thickness by linking of one or more sample substance(s) due to physical, chemical, biological or biochemical reactions or interactions. In this connection, the reagents of the individual spots differ from each other, so that the layer usually exhibits different increases in thickness at the individual spots. The layer is provided on a sample carrier 7 which is irradiated with light from a light source 1.

The light source 1 is a white light source, use being made of a halogen-tungsten lamp in the exemplary embodiment, which has a particularly high-stability light output. The radiation from the light source 1 is received in a condenser 2 which illuminates a subsequent slit aperture 3. Further, cylindrical lenses are provided, so that the illumination slit 3, which is perpendicular to the drawing plane in FIG. 2, emits a line-shaped illumination beam. The latter is transmitted to the sample carrier 7 by relay optics 4 and an objective 6. The radiation passes through a beam splitter 13 and is deflected by a scanning mirror 5. The scanning mirror 5 is rotatable about an axis which is perpendicular to the drawing plane of FIG. 1.

The relay optics 4 and the objective 6 effect telescopic illumination of the sample carrier 7, with the scanning mirror 5 being arranged in the output-side pupil of the objective 6. At the sample carrier 7, the radiation is reflected in itself and passes the scanning mirror 5 again on its way back. The beam splitter 13 splits the reflected radiation in the direction of relay optics 8 and, thus, causes a separation of the illumination beam path from the detection beam path. In the present embodiment, the beam splitter is a wavelength-neutral 1:1 beam splitter.

The sample carrier 7 is located in the object plane of the illumination optics formed by the relay optics 4 and the objective 6, so that the line-shaped beam distribution provided by the illumination slit 3 illuminates a line-shaped portion of the sample. From this line-shaped portion, the reflected radiation is picked up again via the detector optics formed by the relay optics 8 and the objective 6. Said detector optics image the line-shaped portion, from which the reflected radiation was picked up at the sample carrier 7, into an entrance slit 10 of the polychromator 9. The entrance slit 10 serves to minimize scattered light. By means of an optical grating 11, the polychromator 9 spectrally disperses the line-shaped reflection beam introduced at the entrance slit 10 into a two-dimensional field, said spectral dispersion extending transversely to the direction of the line or of the entrance slit. The two-dimensional field, which is schematically represented in FIG. 4, is guided onto a camera 12.

As is evident from FIG. 4, said field consists of individual lines 16-19, which lines represent, in x-direction, the spatial information of the line-shaped portion of the sample carrier 7. Transversely thereto, in lambda direction, the light reflected by the line-shaped portion of the sample carrier 7 is spectrally dispersed; for a simplified representation, FIG. 4 shows only four spectral channels. The number of subdivisions in the x- and lambda-directions is given by the number of pixels of the camera 12 and, in the example, it is 1,000 pixels in the x-direction and 200 pixels in the lambda direction. If one wishes to use a camera 12 which does not have a rectangular detector array, but a square one, either the number of spectral channels may be increased accordingly, or a suitable number of spectral channels may be selected by combining pixels (so-called pixel binning).

The width of a line 16-19 is defined by the width of the line-shaped portion on the sample carrier 7 from which reflections are detected as well as by its imaging into the plane of the entrance slit 10 through the detector optics. It is selected such that one line 16-19 corresponds exactly to one line of pixels of the camera 12.

The scanning mirror 5 is controlled by a control unit in such a way that the line-shaped portion, which the line-shaped illumination beam illuminates on the sample carrier 7 and at which the reflection beam is picked up by the detector optics 6, 8, is displaced over the sample surface. This is schematically represented in FIG. 3, in which the line-shaped portion 7.1 is to be seen, which is moved in a scanning direction 7.3 over the spots 7.2 arranged on the sample carrier 7. In doing so, said movement is effected such that an image frame is recorded by the camera 12 after each displacement of the line-shaped portion 7.1. Thus, one image frame including a spectral analysis of all spots 7.2 covered by the line-shaped portion 7.1 is generated for each position of the line-shaped portion 7.1. The movement of the scanning mirror 5 is effected such that several line scans are effected per spot 7.2, for example 5 to 10. This means that the line-shaped portion 7.1 has completely scanned one row of sample spots 7.2 only after 10 displacements. Thus, the scanner effects both scanning of the sample surface with the line-shaped illumination beam and “descanning” so as to pick up the reflected radiation from the illuminated, line-shaped portion of the sample carrier 7.

For each sample spot, there are several spatially resolved points of measurement, for example 25 to 100, and corresponding spectra which may be used for evaluation. The pixel distribution of the camera is preferably such that a sample spot is covered not only by 10 line displacements, but also by 10 pixels (in the x-direction of FIG. 4).

After the reflected beam has been picked up from a first position of the line-shaped portion 7.1 and recorded as a spectrally dispersed image by the camera 12, the scanning mirror 5 is displaced according to the required spatial resolution, preferably so as to correspond to one pixel of the camera 12, and then, again, a spectrum is recorded for each pixel of this new line by the camera 12. The line displacement with its associated image frame recording is then continued until the entire chip area has been sensed, so that, for each resolvable spatial region, there is an associated spectrum, from which the layer thickness for each spot may be determined via the respective position of extreme values within the spectral composition.

The calculation of the layer thickness distribution over the entire surface area is relatively time-consuming so that the control unit, which also effects said calculation, pre-selects the pixels which are to be associated with a spot. For this purpose, it is envisaged that, from the recorded data, wavelengths or wavelength combinations are selected which have a strong contrast relative to parts of the sample carrier surface without spots. This allows the pixels to be associated with their respective spots, and pixels which do not cover any spots on the sample carrier surface may be suppressed, i.e. masked off. In addition to this association of pixels covering spots, it is convenient to additionally provide an averaging operation and a selection of the spots according to uniform signal levels, so as to eliminate inhomogeneities in spots and freak values caused, for example, by dirt particles or the like.

Optionally, it is also possible, for non-uniformly distributed spots, to exclude pixels deviating from the normal dispersion and respective spectral dispersions.

FIG. 2 shows a different embodiment of the device for sensing the layer thickness on a sample carrier, wherein, contrary to FIG. 1, no vertical incidence of the illumination beam, but an oblique illumination, is used. In the representation of FIG. 2, wherein components corresponding to those of FIG. 1 are identified by the same reference numerals, the illumination slit 3 is located in the drawing plane, so that the line-shaped illumination beam does not extend perpendicular to the drawing plane, as in FIG. 1, but within the drawing plane of FIG. 1. Following the relay optics 4, a deflecting mirror is provided which directs the illumination beam onto the scanning mirror 5.

In the representation of FIG. 2, an intersection line indicated by a broken line is located in the scanning mirror 5, along the axis of which intersection line the lower part of the image has to be rotated by 90°. Thus, in the representation of FIG. 2, the line-shaped illumination beam which is obliquely incident on the sample carrier 7 is shown perpendicular to the drawing plane.

According to the law of reflection, the line-shaped illumination beam is reflected obliquely to the vertical of the sample carrier 7 and directed onto an entrance slit 10 of the polychromator 9 by the detector optics, which are in turn formed by an objective 5 and relay optics 8, said entrance slit 10 being rotated by 90° in the representation of FIG. 2 relative to the representation of FIG. 1, so that the camera 12, which is located in the focal plane of the polychromator, is arranged behind the drawing plane of FIG. 2. Therefore, it is only indicated by dotted lines in FIG. 2.

In the direction of the slit height of the entrance slit 10 (also referred to as sagittal plane), the polychromator has a high spatial resolution. In the present example, it is realized as a Czerny-Turner polychromator. Such polychromator is also known as an imaging spectrometer or as a spectral imager and comprises a planar optical grating. Alternatively, a prism polychromator may be used as well.

The device of FIG. 2 is provided with an adjustable polarization filter 14 following the scanning mirror 5 in the detection beam path, so that different sets of data may be recorded for different polarization directions, e.g. for vertical and parallel polarization directions. Thus, according to the contrast of both signals obtained at different polarizations, a distinction can be made between covered and uncovered surfaces on the sample carrier.

In an optional modification of the device according to FIG. 2, the illumination slit is omitted. Instead, the entire surface of the sample carrier 7 is illuminated by the deflecting mirror, while by-passing the scanning mirror 5. Alternatively, the illumination slit may also be provided such that the illumination aperture is sufficiently large to illuminate the entire surface of the sample carrier. The selection of the line-shaped portion from which reflections are guided to the polychromator to be spectrally dispersed is then carried out by means of the entrance slit and the aperture of the detector optics.

1. A device for spatially resolved measurement of the thickness of a layer present on a sample carrier, said device comprising
a light source (1-3) emitting polychromatic radiation having a predetermined spectral composition,
illumination optics (4-6) illuminating the sample carrier (7) with radiation from the light source (1-3), and
detector optics (6, 5, 8), which pick up reflected radiation from a line-shaped portion of the sample carrier (7) and guide it, as a line-shaped beam, to
a polychromator (9, 11), which separates the line-shaped beam into a planar, multiple-line spectrum.

2. The device as claimed in claim 1, wherein the polychromator (9, 11) is tuned to the spectral composition of the radiation from the light source (1-3).

3. The device as claimed in claim 1 or 2, comprising a camera (12) which receives the planar spectrum.

4. The device as claimed in claim 1, 2 or 3, wherein the illumination optics (4-5) illuminate the line-shaped portion of the sample carrier (7) with a line-shaped illumination beam and wherein the sample carrier (7) is located on a scanning table displaceable perpendicular to the line-shaped portion in such a way that the line-shaped illumination beam is displaceable over the sample carrier (7).

5. The device as claimed in claim 1, 2 or 3, wherein the illumination optics (4-5) illuminate the line-shaped portion of the sample carrier (7) with a line-shaped illumination beam and a scanning means (5) is provided which deflects the illumination beam over the sample carrier (7).

6. The device as claimed in claim 5, wherein the scanning means comprises a movable mirror (5), which directs the illumination beam onto the sample carrier (7) and picks up the reflected radiation.

7. The device as claimed in any one of the above claims, wherein the detector optics (6, 5, 8) comprise an entrance slit (10) preceding the polychromator (9, 11) and an object plane, the sample carrier (7) being arranged in the object plane and being imaged by the detector optics (6, 5, 8) into the plane of the entrance slit (10).

8. The device as claimed in any one of the above claims, wherein the light source (1-3) comprises an illumination slit (3) and preferably anamorphotic optics, which illumination slit (3) generates the line-shaped illumination beam, said illumination optics (4-6) imaging the illumination slit (3) into an object plane in which the sample carrier (7) is located.

9. The device as claimed in any one of claims 5, 7 and 8, comprising a beam splitter (13) arranged between the illumination optics (4-6) and the scanning means (5).

10. The device as claimed in any one of the above claims, wherein the illumination optics obliquely illuminate the sample carrier.

11. The device as claimed in any one of the above claims, wherein the detector optics (6, 5, 8) comprise a polarizer (14).

12. A method of measuring the thickness of a layer present on a sample carrier (7), wherein
the layer is illuminated with polychromatic radiation having a predetermined spectral composition,
reflected radiation is picked up from a line-shaped portion of the layer as a line-shaped reflection beam,
the line-shaped reflection beam is separated into a planar, multiple-line spectrum, and
the radiation intensity of the multiple-line spectrum is detected in a spatially resolved manner.

13. The method as claimed in claim 12, wherein the layer is illuminated by a line-shaped illumination beam which is guided over the sample carrier.

14. The method as claimed in claim 13, wherein the line-shaped portion from which the reflected radiation is picked up is displaced over the sample carrier.
